(19) United States
(12) Patent Application Publication
(10) Pub. No.: US 2023/0224111 A1
(43) Pub. Date: Jul. 13, 2023

(54) MULTIPLE UNIVERSAL SUBSCRIBER IDENTITY MODULE GAP MODIFICATION DURING CRITICAL MOBILITY PROCEDURES

(71) Applicant: Nokia Technologies Oy, Espoo (FI)

(72) Inventors: Laura Luque SANCHEZ, Nibe (DK); Faranaz Sabouri-Sichani, Aalborg (DK); Srinivasan Selvaganapathy, Bangalore (IN)

(21) Appl. No.: 18/061,514

(22) Filed: Dec. 5, 2022

(30) Foreign Application Priority Data
Jan. 10, 2022 (IN) 202241001234

(51) Int. Cl. H04L 5/00; H04L 27/00

(52) U.S. Cl. CPC H04L 5/0046; H04L 5/0048; H04L 27/0006

(57) ABSTRACT

Provided are at least a method and apparatus to perform sending, by a user equipment, towards a network node of a communication network a gap request or receiving, by a network node, from a user equipment of a communication network a gap request, wherein the gap request comprises user equipment information indicating at least one flag indicating that the user equipment can be configured to skip at least one gap occurrence, based on whether at least one of a predefined condition or at least one condition provided by the communication network is met; and communicating information comprising a gap configuration along with conditions for determining whether the network node and the user equipment should be configured to skip at least one gap occurrence based on whether at least one of a predefined condition or at least one condition provided by the communication network is met.

### RELATED APPLICATION

This application claims priority from India Application No. 202241001234, filed on Jan. 10, 2022, which is incorporated herein by reference in its entirety.

### TECHNICAL FIELD

The teachings in accordance with the exemplary embodiments of this invention relate generally to addressing challenges to support mechanisms of multiple universal subscriber identity module and, more specifically, relate to mechanisms of gap configuration or dynamic gap adaptation to optimize multiple universal subscriber identity modules.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| BFD: | beam failure detection |
| BFR: | beam failure recovery |
| DSDA: | dual subscriber identity module dual standby |
| DSDS: | dual subscriber identity module dual active |
| HO: | handover |
| HOF: | handover failure |
| IMSI: | international mobile subscriber identities |
| MNO: | mobile network operator |
| MSC | message sequence chart |
| MT | mobile termination |
| MVNO: | mobile virtual network operator |
| MUSIM: | multiple universal subscriber identity module |
| NTWK: | network |
| RLF: | radio link failure |
| RLR: | radio link recovery |
| RRC | radio resource control |
| SIM | subscriber identity module |
| SUPI: | subscription permanent identifier |
| UAI: | user equipment assistance information |
| UE: | user equipment |
| USIM: | universal subscriber identity module |

Example embodiments of this invention are related to universal subscriber identity module (USIM) management devices. For example, embodiments of the invention relate to USIM management operations for addressing challenges to support MUSIM (Multiple U-SIM) and relate to a context of communication technologies such as but not limited to 3GPP standards submission and work items at the time of this invention.

### BRIEF DESCRIPTION OF THE DRAWINGS

In an example aspect of the invention, there is an apparatus, such as a user equipment side apparatus, comprising: at least one processor; and at least one nontransitory memory storing instructions, that when executed by the at least one processor, cause the apparatus to at least: send, by a user equipment, towards a network node of a communication network a gap request, wherein the gap request comprises user equipment information indicating at least one flag indicating that the user equipment can be configured to skip at least one gap occurrence, and in response to the gap request, receive from the network node information comprising one or more gap occurrences; and in response to the receiving, determine whether the user equipment is to skip at least one gap occurrence of the one or more gap occurrences based on whether at least one of a predefined condition or at least one condition provided by the communication network is met..

In another example aspect of the invention, there is a method comprising: sending, by a user equipment, towards a network node of a communication network a gap request, wherein the gap request comprises user equipment information indicating at least one flag indicating that the user equipment can be configured to skip at least one gap occurrence, and in response to the gap request, receiving from the network node information comprising one or more gap occurrences; and in response to the receiving, determining whether the user equipment is to skip at least one gap occurrence of the one or more gap occurrences based on whether at least one of a predefined condition or at least one condition provided by the communication network is met.

A further example embodiment is an apparatus and a method comprising the apparatus and the method of the previous paragraphs, wherein there is, based on the at least one of a predefined condition or at least one condition provided by the communication network being met, starting a timer; and one of: based on determining the at least one condition has been met before the timer expires, skipping at least one gap occurrence of one or more gap occurrences, or based on the timer expiring before the condition is not met any more, not skipping any of the one or more gap occurrences, wherein the method comprises receiving a radio resource control reconfiguration message from the network node of the communication network, wherein the timer is started based on the radio resource control reconfiguration message from the network node, wherein the radio resource control reconfiguration message is comprising configuration of the condition at which at least one occurrence of one or more configured gap can be cancelled or enabling predefined condition at which at least one occurrence of a one or more configured gap can be cancelled, wherein the at least one of a predefined condition or at least one condition provided by the communication network being met is based on at least one of: the user equipment has sent an even triggered measurement report and expects to receive a mobility command like handover, the user equipment has detected beam failure and expects beam failure recovery command to switch its serving beam, or a presence of traffic with survival time requirements and active survival timer at one of the user equipment and network, wherein measurement report events and beam-failure reporting events which apply are determined via signaling from the network node, wherein the at least one condition is indicated in the user equipment information to the network node, wherein the user equipment comprises more than one universal subscriber identity module, wherein a first universal subscriber identity module of the user equipment is in a connected radio resource control mode with the network node corresponding to a first universal subscriber identity module and a second universal subscriber identity module in an idle or inactive radio resource control mode with a network node corresponding to a second universal subscriber identity module, wherein based on any of the at least one of a predefined condition or at least one condition provided by communication network being met, the at least one gap occurrence is skipped and the first universal subscriber identity module of the user equipment remains in the connected radio resource control mode with the network node corresponding to a first universal subscriber identity module and second universal subscriber identity module of the user equipment remains in the idle or inactive radio resource control mode with a network node corresponding to a second universal subscriber identity module, wherein the at least condition is configured with the radio resource control reconfiguration message received from the communication network node, wherein the at least one condition is predefined and the radio resource control reconfiguration message received from the communication network node acknowledging the receipt of the at least one flag indicating that the user equipment can be configured to skip at least one gap occurrence, wherein the at least one gap occurrence can comprise at least one of periodic or aperiodic gap occurrences, and/or wherein based on the measurement report events and beam-failure reporting events, the user equipment can avoid or delay requests for the aperiodic gap occurrences.

A non-transitory computer-readable medium storing program code, the program code executed by at least one processor to perform at least the method as described in the paragraphs above.

In another example aspect of the invention, there is an apparatus comprising: means for sending, by a user equipment, towards a network node of a communication network a gap request, wherein the gap request comprises user equipment information indicating at least one flag indicating that the user equipment can be configured to skip at least one gap occurrence, and means, in response to the gap request, for receiving from the network node information comprising one or more gap occurrences; and means, in response to the receiving, for determining whether the user equipment is to skip at least one gap occurrence of the one or more gap occurrences based on whether at least one of a predefined condition or at least one condition provided by the communication network is met.

In accordance with the example embodiments as described in the paragraph above, at least the means for sending, receiving, and determining comprises a network interface, and computer program code stored on a computer-readable medium and executed by at least one processor.

In another example aspect of the invention, there is an apparatus, such as a network side apparatus, comprising: at least one processor; and at least one non-transitory memory storing instructions, that when executed by the at least one processor, cause the apparatus to at least: receive, by a network node, from a user equipment of a communication network a gap request, wherein the gap request comprises user equipment information indicating at least one flag indicating that the user equipment can be configured to skip at least one gap occurrence; and in response to the gap request, send by the network node information comprising a gap configuration along with conditions for determining whether the network node and the user equipment should be configured to skip at least one gap occurrence based on whether at least one of a predefined condition or at least one condition provided by the communication network is met.

In another example aspect of the invention, there is a method comprising: receiving, by a network node, from a user equipment of a communication network a gap request, wherein the gap request comprises user equipment information indicating at least one flag indicating that the user equipment can be configured to skip at least one gap occurrence; and in response to the gap request, sending by the network node information comprising a gap configuration indicating one or more gap occurrences along with conditions for determining whether the network node and the user equipment should be configured to skip at least one gap occurrence of the one or more gap occurrences based on whether at least one of a predefined condition or at least one condition provided by the communication network is met.

A further example embodiment is an apparatus and a method comprising the apparatus and the method of the previous paragraphs, wherein the at least one of a predefined condition or at least one condition provided by the communication network being met is based on at least one of: receiving from the user equipment an event triggered measurement report to receive a mobility command like handover, the user equipment has detected beam failure and expects beam failure recovery command to switch its serving beam, or a presence of traffic with survival time requirements and active survival timer at one of the user equipment and network, wherein the radio resource control reconfiguration message is comprising configuration of at least one condition at which at least one occurrence of one or more configured gap occurrences can be cancelled or enabling specified conditions of the at least one of a predefined condition at which at least one or more gap occurrences can be cancelled, wherein the radio resource control reconfiguration message causes the network node to: based on determining the at least one condition has been met before the timer expires, skip at least one gap occurrence of the one or more gap occurrences, or based on the timer expiring before the condition is not met any more, not skip any of the one or more gap occurrences, wherein the at least one condition is indicated in user equipment information associated with the gap request from the user equipment, wherein the at least one condition is provided to the user equipment with the radio resource control reconfiguration message, wherein the at least one predefined condition being enabled upon receiving information from the user device comprising the gap request and the flag indicating that the user equipment can be configured to skip at least one gap occurrence of the one or more gap occurrences; and the method comprising sending toward the user equipment in the radio resource control reconfiguration message response an acknowledgement of the information from the user equipment, wherein the at least one gap occurrence can comprise at least one of periodic or aperiodic gap occurrences, wherein based on the conditions being met the network node skips the gap and continues scheduling the user equipment, and/or wherein event triggered measurement report events and detected beam-failure reporting events which apply are indicated in the information from the network node.

A non-transitory computer-readable medium storing program code, the program code executed by at least one processor to perform at least the method as described in the paragraphs above.

In another example aspect of the invention, there is an apparatus comprising: means for receiving, by a network node, from a user equipment of a communication network a gap request, wherein the gap request comprises user equipment information indicating at least one flag indicating that the user equipment can be configured to skip at least one gap occurrence; and means, in response to the gap request, for sending by the network node information comprising a gap configuration indicating one or more gap occurrences along with conditions for determining whether the network node and the user equipment should be configured to skip at least one gap occurrence of the one or more gap occurrences based on whether at least one of a predefined condition or at least one condition provided by the communication network is met.

In accordance with the example embodiments as described in the paragraph above, at least the means for sending and receiving comprises a network interface, and computer program code stored on a computer-readable medium and executed by at least one processor.

A communication system comprising the network side apparatus and the user equipment side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

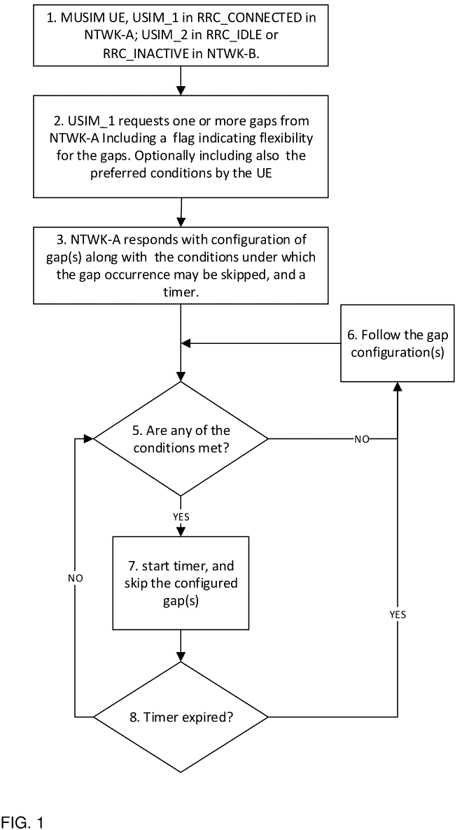

FIG. 1 shows a flow chart related to enhancement of multiple universal subscriber identity module gaps in accordance with example embodiments of the invention;

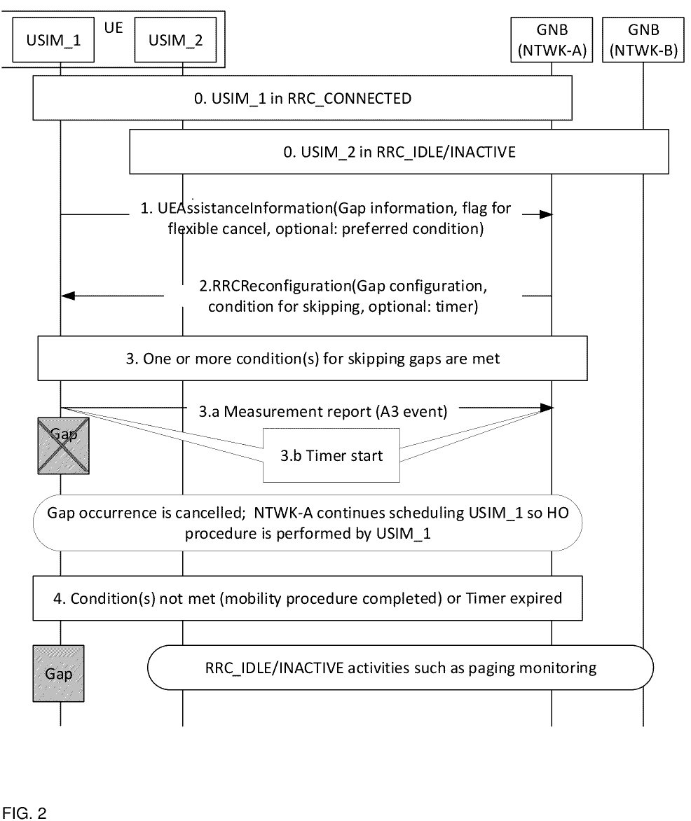

FIG. 2 shows Message Sequence Chart configurations for the option 1 of a solution in accordance with example embodiments of the invention;

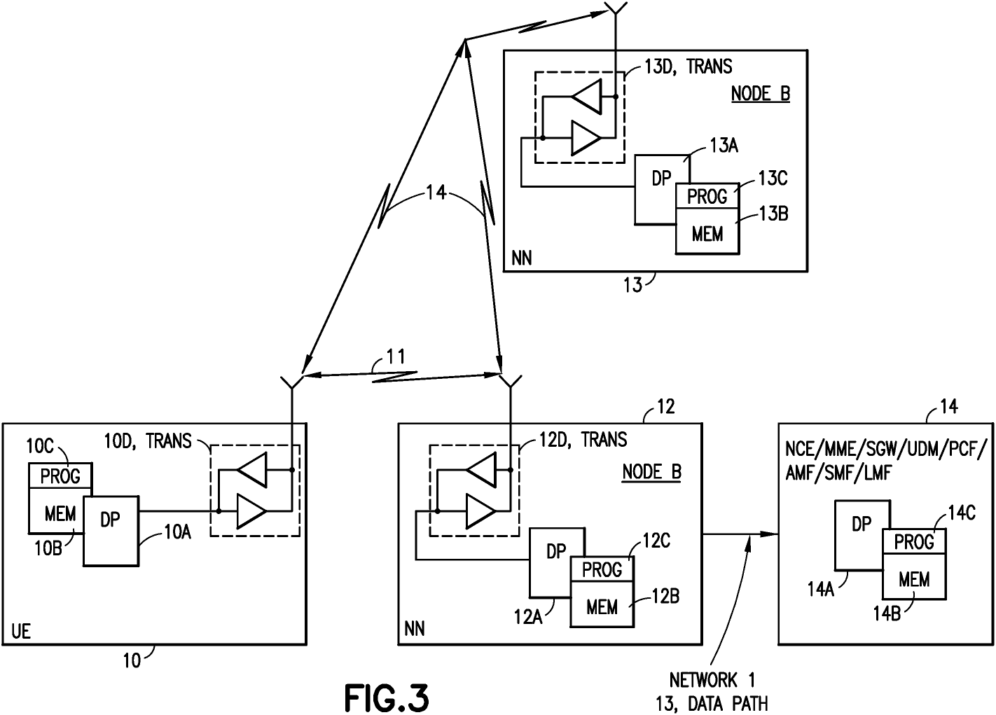

FIG. 3 shows a high-level block diagram of various devices used in carrying out various aspects of the invention; and

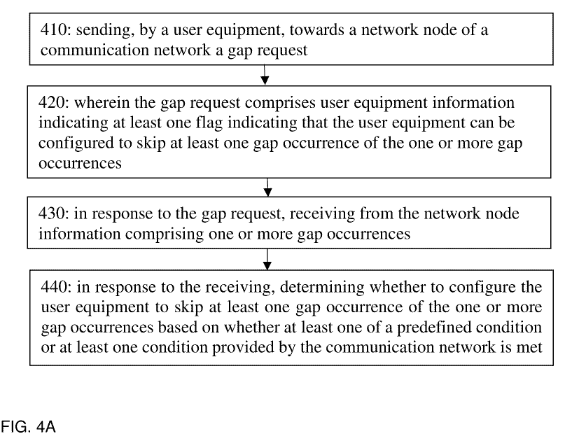

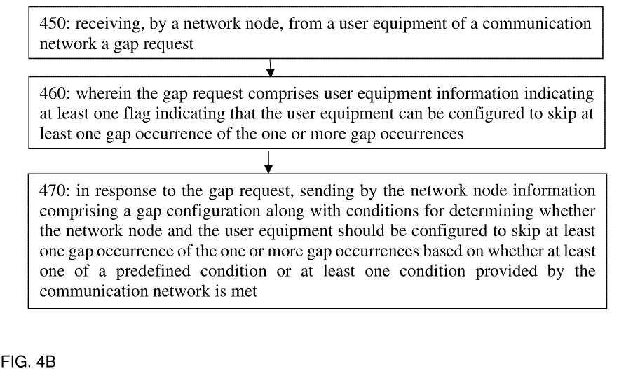

FIG. 4A and FIG. 4B each show a method in accordance with example embodiments of the invention which may be performed by an apparatus.

### DETAILED DESCRIPTION

In this invention, example embodiments of the invention as disclosed herein at least relate to mechanisms of gap configuration or dynamic gap adaptation to optimize MUSIM.

Example embodiments of the invention as disclosed in this application are addressing challenges to support MUSIM (Multiple U-SIM). These embodiments are made to provide support for MUSIM devices in the context of communication technologies such as and not limited to 3GPP work items and standards submissions at the time of this application.

### MUSIM Devices and Operation

A multi-USIM device has two (Dual) or more (Multiple) simultaneous 3GPP/3GPP2 network subscriptions with multiple corresponding International Mobile Subscriber Identities (IMSI) in case of EPS or Subscription Permanent Identifier (SUPI) in case of 5GS each associated with a particular subscription belonging to the same or different Mobile Network Operator (MNO (/Mobile Virtual Network Operator (MVNO)).

In today’s phones, the maximum number of supported USIMs is two. However, there has been at least one example of a phone supporting triple-SIM. With the introduction of electronic SIM (e-SIM), it is to be expected that some phones will arrive to the public market with support for more than two USIMs.

The UE’s behaviour with respect to the simultaneous handling of multiple USIMs may depend on the UE’s capabilities related to concurrent independent RX and/or TX operations as listed below:
SingleRx / SingleTx: The UE is only capable of receiving traffic from one network and and/or transmitting traffic to one network at a time (type 1),
DualRx / SingleTx: The UE is capable of simultaneously receiving traffic from two networks but is capable of transmitting to only one network at a time (type 2), and
DualRx /DualTx: The UE is capable of simultaneously receiving and/or transmitting to/from two networks (type 3).

SingleRX/singleTX devices cannot receive paging or perform other idle/inactive mode reception activities in one USIM while in RRC_connected mode in another USIM. Hence, the MUSIM device needs to gap its RRC connection when it has to perform any activity for the idle/inactive UE such as paging monitoring, performing measurements, etc.

3GPP has agreed to allow the UE to perform such (short) activities on NTWK-B without leaving NTWK-A to avoid that UE needs to leave the RRC connection with NTWK-A, by requesting MUSIM gaps. It is agreed in standards at the time of this application that a UE can request several gap patterns for this purpose. More specifically minimum two periodic and one aperiodic gap are agreed in in standards at the time of this application (FFS whether more gaps are allowed).

These gap patterns are requested by the UE in the RRC message UEAssistanceInformation (UAI) indicating the duration, periodicity and start time. If NTWK-A grants the requested gap patterns, it stops scheduling any data for that UE when the gap is active, so the UE can perform the needed activity in NTWK-B.

### Mobility Procedures

A UE in RRC connected mode will experience a variation in the radio conditions due to its mobility as well as changes in its environment. To maintain the RRC connection with acceptable QoS the UE is monitoring intra-cell and inter-cell radio conditions by doing beam level as well as cell level measurements, which may trigger procedures to improve the radio link condition for the UE. Some measurements and the corresponding mobility procedure are listed below:
Radio Resource Management (RRM): UE performs measurements on its serving cell as well as a configured set of neighboring cells monitoring the DL radio link signal / quality and transmit (event-based) measurement reporting (e.g., A3 event). The NTWK may then decide to handover the UE’s serving cell to a new cell,
Radio Link Monitoring (RLM): UE performs RLM measurements to detect radio link failure (RLF). When RLF report is sent to the NTWK radio link recovery (RLR) procedure is initiated and new configuration (from same or new cell) is provided to the UE for re-establishment, and
Beam Failure Detection (BFD): UE is performing beam level measurements to monitor the quality of certain beams, and if beam failure is detected, beam failure recovery is triggered

SingleRX/singleTX devices cannot receive paging or perform other RRC_IDLE/RRC_INACTIVE mode reception activities in one USIM while in RRC_CONNECTED mode in another USIM. Hence, the MUSIM device needs to gap its RRC connection when it has to perform any activity for the idle/inactive UE.

Once the gap pattern is requested by the UE in RRC_CONNECTED and accepted by NTWK-A, any ongoing activity in the RRC_CONNECTED UE is put on hold for the duration of the gap at every gap occurrence.

Due to the varying radio conditions due to UE’s mobility, mobility procedures such as handover, RLF, or BFR reporting and re-establishment procedures are needed. In such cases, the UE may be performing a critical mobility procedure and an interruption (gap occurrence) may cause the UE to lose the connection due to handover failure, radio link recovery failure, or beam recovery failure. This would mean extra time (delay) and power consumption for the UE and network and it also would significantly decrease the user experience.

Before describing the example embodiments of the invention in detail, reference is made to FIG. 3 for illustrating a simplified block diagram of various electronic devices that are suitable for use in practicing the example embodiments of this invention.

FIG. 3 shows a block diagram of one possible and non-limiting exemplary system in which the example embodiments of the invention may be practiced. In FIG. 3, a user equipment (UE) 10 is in wireless communication with a wireless network 1 or network, 1 as in FIG. 3. The wireless network 1 or network 1 as in FIG. 3 can comprise a communication network such as a mobile network e.g., the mobile network 1 or first mobile network as disclosed herein. Any reference herein to a wireless network 1 as in FIG. 3 can be seen as a reference to any wireless network as disclosed herein. Further, the wireless network 1 as in FIG. 3 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 3. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices such as, but not limited to an NCE/MME/SGW/UDM/PCF/AMF/SMF/LMF 14 device as in FIG. 3. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or link 14 or another link. The Link 14 as shown in FIG. 3 can be used for communication between the NN12 and the NN13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF/LMF 14 of FIG. 3.

The one or more buses of the device of FIG. 3 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to a RRH.

It is noted that although FIG. 3 shows a network nodes such as NN 12 and NN 13, any of these nodes may can incorporate or be incorporated into an eNodeB or eNB or gNB such as for LTE and NR, and would still be configurable to perform example embodiments of the invention.

Also, it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or NN 13 and/or UE 10 can be configured (e.g., based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF such as the LMF of the MME/SGW/UDM/PCF/AMF/SMF/LMF 14 of FIG. 3, as at least described below, can be co-located with UE 10 such as to be separate from the NN 12 and/or NN 13 of FIG. 3 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

As similarly stated above, example embodiments of this invention address the need for a MUSIM device in RRC connection with one of its USIMs, which has one or more MUSIM gap patterns configured by network for paging monitoring or any other activity in its USIM in RRC idle or inactive, to skip/cancel a gap occurrence in case of a critical ongoing mobility procedure. The idea in accordance with some example embodiments of the invention is to provide means to cancel one or more gap occurrence(s) dynamically based on predefined conditions aligned between the UE and the network to avoid the RRC_CONNECTED UE to experience unnecessary performance degrade (e.g., throughput) and in worst case lose its connection due to delayed mobility procedure.

FIG. 1 shows a flow chart related to enhancement of multiple universal subscriber identity module gaps in accordance with example embodiments of the invention.

High level summary of an enhancement in accordance with some example embodiments of the invention is given below:
At 110, a MUSIM UE is in RRC_CONNECTED in NTWK-A and RRC_IDLE or RRC_INACTIVE in NTWK-B. The UE at 120 requests one or more sets of gap configurations from NTW-A for the necessary activities toward NTWK-B. The communication related to UE’s gap request is part of agreed switching notification without leaving connected mode network in 3GPP and contains gap duration, offset and periodicity. The gaps can be periodic or aperiodic.

Changes with dynamic disabling of Gaps in synchronous manner for critical events:
The gap request may include a flag in the UE Assistance Information (UAI) message to indicate to the network that the UE is flexible to skip some gap occurrence(s) if/when it may be necessary due to critical traffic or procedure running in the RRC connection;
One or more gap occurrences may be cancelled if predefined or configured conditions are met. Where the conditions may be configured by the network along with the configuration of requested gap from the UE.
The duration to disable the gap can also be configuration parameter depending on the event;
These conditions may comprise below the non-limiting scenarios:
   the UE has sent an event-triggered measurement report (e.g., A3 event which is triggered when a neighbor cell becomes better than a serving cell by an offset) and expects to receive a mobility command like handover (i.e., the measurement event configured with T312), or
   The UE has detected beam failure and expects beam failure recovery command to switch its serving beam,
   Presence of traffic with survival time requirements and active survival timer at UE and network;
The at least one condition may be defined in different ways:
   In one embodiment of this application the one or more conditions are provided by the NTWK-A as a response to the UE gap request in UAI with flag indicating its flexibility for skipping gap occurrence(s):
      In one embodiment, the preferred conditions may be indicated by the UE in the UAI, together with the flag,
   o In one embodiment of this application the one or more conditions may be predefined in the 3GPP radio resource control specification. In this case, the UE just needs to enable it using the flag along with its request for gap configuration and the network response provides the requested gap configuration and also acknowledge that it may use such feature, so both, UE and network are aligned;
At 130, after RRCReconfiguration from NTWK-A, including the gap configuration and optionally indicating the cancellation condition configuration or enabling specified conditions, NTWK-A and UE are aligned on the conditions at which the gaps can be skipped;
UE and network operate as usual applying the configured gap patterns. If, at 150, any of the conditions is met, at 170 the gap occurrence is skipped i.e., NTWK-A skips the gap (i.e., continues scheduling the UE) and the UE will not switch to the RRC Idle/Inactive UE. If the conditions are not met, the configured gap patterns will be followed at 160. Skipping the gap may be for a single occurrence or continue until the critical procedure is completed; and/or
To avoid the UE is skipping its idle/inactive mode operation for too long, a timer may be specified at 170, which may optionally be included at 130. In case the timer expires at 180 before the critical procedure completes, the gap configuration may not be ignored anymore. In other words, the gap configuration is ignored as long as the critical procedure is not completed or the timer is not expired - whichever occurs first.

Changes by avoiding triggering of aperiodic gap UAI for specific critical events:
For measurement reports and beam-failure reporting events, UE may also avoid or delay requesting for aperiodic gaps. Which events this behavior should be applied to can also be configured by network via signalling.

The corresponding Message sequence chart for a solution is shown in FIG. 2. FIG. 2 shows Message Sequence Chart configurations for the option 1 of a solution in accordance with example embodiments of the invention. This Message sequence chart for a solution is explained in detail below:
0. A MUSIM UE with a first USIM (USIM_1) in RRC_CONNECTED with NTWK-A and a second USIM (USIM_2) in RRC_IDLE or RRC_INACTIVE with NTWK-B;

1. USIM_1 sends a UEAssistanceInformation message to request to NTWK-A one or more gap patterns to allow the USIM_2 to perform activities towards NTWK-B. These activities may be related but non-limited to paging monitoring and/or measurements. The message includes gap information such as gap length, gap periodicity, and gap location (offset), and further includes:
   a flag in the UAI that indicates to NTWK-A that, in the requested gap, some occurrences may be ignored or cancelled if certain conditions are met,
   The conditions may be related, but not limited, to critical procedures that USIM_1 may need to perform. Some examples could be related to mobility procedure that USIM_1 has transmitted a measurement report based on a measurement reporting event which triggers a handover in which case a handover command is expected,
   In one embodiment, the UE may provide its preferred conditions for under which one or more gap occurrences may to be skipped;
2. In response NTWK-A sends an RRCReconfiguration message in which it provides the configuration based on the received gap information along with the conditions under which one or more gap occurrences may be cancelled/skipped:
   The decision about the conditions may be made by the network without receiving any preference from the UE,
   The decision may consider the preferred conditions provided by UE in step 1 (although the final decision is on the network),
   In another embodiment, the network just needs to confirm that it supports the gap cancellation based on predefined conditions in 3GPP specifications, and/or
   Optionally, it may also include a timer specifying the max allowed time the configured gap(s) may be skipped;
3. Once the network and UE are aligned, they evaluate whether one or more condition(s) is/are met at every gap occurrence, in which case the gap is cancelled. In such case, the NTWK-A continues scheduling USIM_1 so it can continue/complete the critical procedure and the UE does not switch to USIM_2:
   a) As an example, UE sends a measurement report which triggers event A3 (handover). Thus, one of the required conditions is met, and
   b) If a timer was included in the RRCReconfiguration message, both USIM_1 and NTWK-A will start the timer;
4. If the condition(s) is(are) not met (e.g., an ongoing or predicted mobility procedure is completed) or the timer expires, UE and NTWK revert back to normal operation with the agreed gap configuration.

FIG. 4A illustrates operations which may be performed by a device such as, but not limited to, a device (e.g., the UE 10 as in FIG. 3). As shown in step 410 of FIG. 4A there is sending, by a user equipment, towards a network node of a communication network a gap request. As shown in step 420 of FIG. 4A wherein the gap request comprises user equipment information indicating at least one flag indicating that the user equipment can be configured to skip at least one gap occurrence. As shown in step 430 of FIG. 4A there is in response to the gap request, receiving from the network node information comprising one or more gap occurrences. Then as shown in step 440 of FIG. 4A there is in response to the receiving, determining whether to configure the user equipment to skip at least one gap occurrence of the one or more gap occurrences based on whether at least one of a predefined condition or at least one condition provided by the communication network is met.

In accordance with the example embodiments as described in the paragraphs above, there is based the at least one of a predefined condition or at least one condition provided by the communication network being met, starting a timer; and one of: based on determining the at least one condition has been met before the timer expires, skipping at least one gap occurrence of the one or more gap occurrences for performing the mobility procedure, or based on the timer expiring before the mobility procedure is completed, not skipping any of the one or more gap occurrences.

In accordance with the example embodiments as described in the paragraphs above, wherein the method comprises receiving a radio resource control reconfiguration message from the network node of the communication network, wherein the timer is started when the at least one of a predefined condition or at least one condition provided by the communication network has been met.

In accordance with the example embodiments as described in the paragraphs above, wherein the radio resource control reconfiguration message is comprising configuration of the condition at which at least one occurrence of one or more configured gap can be cancelled or enabling predefined condition at which at least one occurrence of a one or more configured gap can be cancelled.

In accordance with the example embodiments as described in the paragraphs above, wherein the at least one of a predefined condition or at least one condition provided by the communication network being met is based on but not limited to at least one of: the user equipment has sent an event-triggered measurement report and expects to receive a mobility command like handover, the user equipment has detected beam failure and expects beam failure recovery command to switch its serving beam, or a presence of traffic with survival time requirements and active survival timer at one of the user equipment and network.

In accordance with the example embodiments as described in the paragraphs above, wherein the at least one gap occurrence is skipped based on but not limited to at least one of: the user equipment has sent an event-triggered measurement report and expects to receive a mobility command like handover, the user equipment has detected beam failure and expects beam failure recovery command to switch its serving beam, or a presence of traffic with survival time requirements and active survival timer at one of the user equipment and network.

In accordance with the example embodiments as described in the paragraphs above, wherein the measurement report events and beam-failure reporting events which apply are determined via signaling from the network node.

In accordance with the example embodiments as described in the paragraphs above, wherein the at least one of a predefined condition or at least one condition provided by the communication network is indicated in the user equipment information to the network node.

In accordance with the example embodiments as described in the paragraphs above, wherein the user equipment comprises more than one universal subscriber identity module.

In accordance with the example embodiments as described in the paragraphs above, wherein a first universal subscriber identity module of the user equipment is in a connected radio resource control mode with the network node corresponding to a first universal subscriber identity module and a second universal subscriber identity module in an idle or inactive radio resource control mode with a network device corresponding to a second universal subscriber identity module.

In accordance with the example embodiments as described in the paragraphs above, wherein based on any of the at least one of a predefined condition or at least one condition provided by the communication network being met, the at least one gap occurrence is skipped and the first universal subscriber identity module of the user equipment remains in the connected radio resource mode with the network node corresponding to a first universal subscriber identity module and second universal subscriber identity module of the user equipment remains in the idle or inactive radio resource control mode with the network node corresponding to a second universal subscriber identity module.

In accordance with the example embodiments as described in the paragraphs above, wherein the at least one of a predefined condition or at least one condition provided by the communication network is predefined with the with the radio resource control reconfiguration message.

In accordance with the example embodiments as described in the paragraphs above, wherein the at least one condition is predefined and the radio resource control reconfiguration message received from the communication network node acknowledge the receipt of the at least one flag indicating that the user equipment can be configured to skip at least one gap occurrence.

In accordance with the example embodiments as described in the paragraphs above, wherein the at least one gap occurrence can comprise at least one of periodic or aperiodic gap occurrences.

In accordance with the example embodiments as described in the paragraphs above, wherein based on the measurement reporting events and/or beam-failure reporting events, the user equipment can avoid or delay transmitting requests to the communication network for the aperiodic gap occurrences.

In accordance with an example embodiment of the invention as described above there is an apparatus comprising: means for sending (TRANS 10D, MEM 10B, PROG 10C, and DP 10A as in FIG. 3), by a user equipment (UE 10 as in FIG. 3), towards a network node of a communication network (network 1 as in FIG. 3) a gap request, wherein the gap request comprises user equipment information indicating at least one flag indicating that the user equipment can be configured to skip at least one gap occurrence of the one or more gap occurrences, and means in response to the gap request, for receiving (TRANS 10D, MEM 10B, PROG 10C, and DP 10A as in FIG. 3) from the network node information comprising one or more gap occurrences; and in response to the receiving, determining (TRANS 10D, MEM 10B, PROG 10C, and DP 10A as in FIG. 3) whether to configure the user equipment to skip at least one gap occurrence of the one or more gap occurrences based on whether at least one of a predefined condition or at least one condition provided by the communication network is met.

In the example aspect of the invention according to the paragraph above, wherein at least the means for sending, receiving, and determining comprises a non-transitory computer readable medium [MEM 10B as in FIG. 3] encoded with a computer program [PROG 10C as in FIG. 3] executable by at least one processor [DP 10A as in FIG. 3].

FIG. 4B illustrates operations which may be performed by a network device such as, but not limited to, a network node NN 12 or NN 13 as in FIG. 3 or an eNB. As shown in step 450 of FIG. 4B there is receiving, by a network node, from a user equipment of a communication network a gap request. As shown in step 460 of FIG. 4B wherein the gap request comprises user equipment information indicating at least one flag indicating that the user equipment can be configured to skip at least one gap occurrence of the one or more gap occurrences. Then as shown in step 470 of FIG. 4B there is in response to the gap request, sending by the network node information comprising a gap configuration along with conditions for determining whether the network node and the user equipment should be configured to skip at least one gap occurrence of the one or more gap occurrences based on whether at least one of a predefined condition or at least one condition provided by the communication network is met.

In accordance with the example embodiments as described in the paragraphs above, there is sending a radio resource control reconfiguration message towards the user equipment of the communication network, wherein the radio resource control reconfiguration message causes a timer to be started by the network node based on whether the at least one of a predefined condition or at least one condition provided by the communication network is met.

In accordance with the example embodiments as described in the paragraphs above, wherein the at least one of a predefined condition or at least one condition provided by the communication network being met is based on but not limited to at least one of: receiving from the user equipment an event-triggered measurement report to receive a mobility command like handover, the user equipment has detected beam failure and expects beam failure recovery command to switch its serving beam, or a presence of traffic with survival time requirements and active survival timer at one of the user equipment and network.

In accordance with the example embodiments as described in the paragraphs above,

wherein the radio resource control reconfiguration message is comprising configuration of at least one condition at which at least one occurrence of one or more configured gap can be cancelled or enabling specified conditions of the at least one of a predefined condition at which at least one occurrence of a one or more configured gap can be cancelled.

In accordance with the example embodiments as described in the paragraphs above, wherein the at least one predefined condition being enabled upon receiving information from the user device comprising the gap request and the flag indicating that the user equipment can be configured to skip at least one gap occurrence of the one or more gap occurrences; and the method comprising sending toward the user equipment in the radio resource control reconfiguration message response an acknowledgement of the information from the user equipment.

In accordance with the example embodiments as described in the paragraphs above, wherein the radio resource control reconfiguration message causes the user equipment to: based on determining the at least one condition has been met before the timer expires, skip at least one gap occurrence of the one or more gap occurrences for performing the mobility procedure, or based on the timer expiring before the mobility procedure is completed, not skip any of the one or more gap occurrences.

In accordance with the example embodiments as described in the paragraphs above, wherein the at least one of a predefined condition or at least one condition provided by the communication network is indicated in user equipment information associated with the gap request from the user equipment.

In accordance with the example embodiments as described in the paragraphs above, wherein the at least one of a predefined condition or at least one condition is predefined with the radio resource control reconfiguration message.

In accordance with the example embodiments as described in the paragraphs above, wherein the at least one gap occurrence is skipped based on at least one of: the user equipment has sent an event-triggered measurement report and expects to receive a mobility command like handover, the user equipment has detected beam failure and expects beam failure recovery command to switch its serving beam, or a presence of traffic with survival time requirements and active survival timer at one of the user equipment and network.

In accordance with the example embodiments as described in the paragraphs above, wherein the at least one gap occurrence can comprise at least one of periodic or aperiodic gap occurrences.

In accordance with the example embodiments as described in the paragraphs above, wherein the at least one gap occurrence is skipped based on but not limited to at least one of: the user equipment has sent an event-triggered measurement report and expects to receive a mobility command like handover, the user equipment has detected beam failure and expects beam failure recovery command to switch its serving beam, or a presence of traffic with survival time requirements and active survival timer at one of the user equipment and network.

In accordance with the example embodiments as described in the paragraphs above, wherein the at least one gap occurrence is skipped based on at least one of:
the communication network has received an event-triggered measurement report from user equipment and the user equipment expects to receive a mobility command like handover,
the user equipment has detected beam failure and expects beam failure recovery command to switch its serving beam, or a presence of traffic with survival time requirements and active survival timer at one of the user equipment and network

In accordance with the example embodiments as described in the paragraphs above, the network node skips the gap and continues scheduling the user equipment.

In accordance with the example embodiments as described in the paragraphs above, wherein event-triggered measurement report events and detected beam-failure reporting events which apply are indicated in the information from the network node.

In accordance with the example embodiments as described in the paragraphs above, wherein event-triggered measurement reporting events and detected beam-failure reporting events which may be delayed by the UE are indicated in the information from the network node.

In accordance with an example embodiment of the invention as described above there is an apparatus comprising: means for receiving (TRANS 12D or TANS 13D, MEM 12B or MEM 13B, PROG 12C or PROG 13C, and DP 12A or DP 13A as in FIG. 3), by a network node (NN12 or NN13 as in FIG. 3), from a user equipment (UE 10 as in FIG. 3) of a communication network (Network 1 as in FIG. 3) a gap request, wherein the gap request comprises user equipment information indicating at least one flag indicating that the user equipment can be configured to skip at least one gap occurrence of the one or more gap occurrences; and in response to the gap request, sending (TRANS 12D or TANS 13D, MEM 12B or MEM 13B, PROG 12C or PROG 13C, and DP 12A or DP 13A as in FIG. 3) by the network node information comprising one or more gap occurrences, wherein the information comprises the gap configuration along with conditions for determining whether the user equipment and the network node should be configured to skip at least one gap occurrence of the one or more gap occurrences based on whether at least one of a predefined condition or at least one condition provided by the communication network is met.

In the example aspect of the invention according to the paragraph above, wherein at least the means for receiving and sending comprises a non-transitory computer readable medium [MEM 12B or MEM 13B as in FIG. 3] encoded with a computer program [PROG 12C or PROG 13C as in FIG. 3] executable by at least one processor [DP 12A or DP 13A as in FIG. 3].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.

In accordance with example embodiments of the invention, there is adequate circuitry for performing at least the operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. An apparatus comprising:
at least one processor; and
at least one non-transitory memory including computer program code, where the at least one non-transitory memory and the computer program code are configured, with the at least one processor, to cause the apparatus to at least:
send, by a user equipment, towards a network node of a communication network a gap request,
wherein the gap request comprises user equipment information indicating at least one flag indicating that the user equipment can be configured to skip at least one gap occurrence;
in response to the gap request, receive from the network node information comprising one or more gap occurrences; and
in response to the receiving, determine whether the user equipment is to skip at least one gap occurrence of the one or more gap occurrences based on whether at least one of a predefined condition or at least one condition provided by the communication network is met.

2. The apparatus of claim 1, wherein the apparatus is further caused to:
based on the at least one of a predefined condition or at least one condition provided by the communication network being met, start a timer; and one of:
based on determining the at least one condition has been met before the timer expires, skip at least one gap occurrence of the one or more gap occurrences, or
based on the timer expiring before the condition is not met any more, not skip any of the one or more gap occurrences.

3. The apparatus of claim 2, wherein the apparatus is further caused to:
receive a radio resource control reconfiguration message from the network node of the communication network, wherein the timer is started based on the radio resource control reconfiguration message from the network node.

4. The apparatus of claim 3, wherein the radio resource control reconfiguration message is comprising configuration of the condition at which at least one occurrence of one or more configured gap can be cancelled or enabling predefined condition at which at least one occurrence of a one or more configured gap can be cancelled.

5. The apparatus of claim 4, wherein the at least condition is configured with the radio resource control reconfiguration message received from the communication network node.

6. The apparatus of claim 4, wherein the at least one condition is predefined and the radio resource control reconfiguration message received from the communication network node acknowledge the receipt of the at least one flag indicating that the user equipment can be configured to skip at least one gap occurrence.

7. The apparatus of claim 1, wherein the at least one of a predefined condition or at least one condition provided by the communication network being met is based on at least one of:
the user equipment has sent an event-triggered measurement report and expects to receive a mobility command like handover,
the user equipment has detected beam failure and expects beam failure recovery command to switch its serving beam, or
a presence of traffic with survival time requirements and active survival timer at one of the user equipment and network.

8. The apparatus of claim 7, wherein measurement report events and beam-failure reporting events which apply are determined via signaling from the network node.

9. The apparatus of claim 8, wherein based on the measurement report events and beam-failure reporting events, the user equipment can avoid or delay requests for the aperiodic gap occurrences.

10. The apparatus of claim 1, wherein the at least one condition is indicated in the user equipment information to the network node.

11. The apparatus of claim 1, wherein the user equipment comprises more than one universal subscriber identity module.

12. The apparatus of claim 11, wherein a first universal subscriber identity module of the user equipment is in a connected radio resource control mode with the network node corresponding to a first universal subscriber identity module and a second universal subscriber identity module in an idle or inactive radio resource control mode with a network node corresponding to a second universal subscriber identity module.

13. The apparatus of claim 12, wherein based on any of the at least one of a predefined condition or at least one condition provided by communication network being met, the at least one gap occurrence is skipped and the first universal subscriber identity module of the user equipment remains in the connected radio resource control mode with the network node corresponding to a first universal subscriber identity module and second universal subscriber identity module of the user equipment remains in the idle or inactive radio resource control mode with a network node corresponding to a second universal subscriber identity module.

14. The apparatus of claim 1, wherein the at least one gap occurrence can comprise at least one of periodic or aperiodic gap occurrences.

15. A method, comprising:
sending, by a user equipment, towards a network node of a communication network a gap request,
wherein the gap request comprises user equipment information indicating at least one flag indicating that the user equipment can be configured to skip at least one gap occurrence, and
in response to the gap request, receiving from the network node information comprising one or more gap occurrences; and
in response to the receiving, determining whether the user equipment is to skip at least one gap occurrence of the one or more gap occurrences based on whether at least one of a predefined condition or at least one condition provided by the communication network is met.

16. An apparatus comprising:
at least one processor; and
at least one non-transitory memory including computer program code, where the at least one non-transitory memory and the computer program code are configured, with the at least one processor, to cause the apparatus to at least:
receive, by a network node, from a user equipment of a communication network a gap request,
wherein the gap request comprises user equipment information indicating at least one flag indicating that the user equipment can be configured to skip at least one gap occurrence; and
in response to the gap request, send by the network node information comprising a gap configuration indicating one or more gap occurrences along with conditions for determining whether the network node and the user equipment should be configured to skip at least one gap occurrence of the one or more gap occurrences based on whether at least one of a predefined condition or at least one condition provided by the communication network is met.

17. The apparatus of claim 16, comprising:
sending a radio resource control reconfiguration message towards the user equipment of the communication network, wherein the radio resource control reconfiguration message causes a timer to be started by the network node based on the at least one of a predefined condition or at least one condition provided by the communication network being met.

18. The apparatus of claim 17, wherein the at least one of a predefined condition or at least one condition provided by the communication network being met is based on at least one of:
receiving from the user equipment an event-triggered measurement report to receive a mobility command like handover,
the user equipment has detected beam failure and expects beam failure recovery command to switch its serving beam, or
a presence of traffic with survival time requirements and active survival timer at one of the user equipment and network.

19. The apparatus of claim 17, wherein the radio resource control reconfiguration message is comprising configuration of at least one condition at which at least one occurrence of one or more configured gap can be cancelled or enabling specified conditions of the at least one of a predefined condition at which at least one occurrence of a one or more configured gap can be cancelled.

20. The apparatus of claim 17, wherein the radio resource control reconfiguration message causes the network node to:
based on determining the at least one condition has been met before the timer expires, skip at least one gap occurrence of the one or more gap occurrences, or
based on the timer expiring before the condition is not met any more, not skip any of the one or more gap occurrences.
